(19) United States
(12) Patent Application Publication
(10) Pub. No.: US 2012/0213682 A1
(43) Pub. Date: Aug. 23, 2012

(54) NOVEL SORBENTS FOR MERCURY REMOVAL

(76) Inventors: Maohong Fan, Ames, IA (US); Morris Argyle, Provo, UT (US); Rodolfo Monterrozo, Laramie, WY (US)

(21) Appl. No.: 13/276,844

(22) Filed: Oct. 19, 2011

Related U.S. Application Data
(60) Provisional application No. 61/394,604, filed on Oct. 19, 2010.

(51) Int. Cl. B01D 53/64; B01J 20/30; B01J 20/20

(52) U.S. Cl. 423/210; 252/184

(57) ABSTRACT

The adsorption of vapor phase elemental mercury onto the commercially produced Thief carbon and impregnated Thief carbon with ferric chloride and sodium chloride is disclosed. The results indicate that the impregnation of these sorbents enhanced considerably their capacity and changed the sorption mechanism. Ferric chloride impregnated Thief carbon sorbents presented the highest sorption capacity.

This application claims priority to U.S. Patent Application Ser. No. 61/394,604, filed Oct. 19, 2010, and incorporated herein in its entirety by this reference.

This material is based upon work supported by the U.S. Department of Energy, under special project number DE-FC26-06NT42811.

The present invention relates generally to the adsorption of mercury and, more specifically, to the adsorption of vapor phase elemental mercury onto carbon sorbents that have been impregnated with compounds that improve the level of adsorption. Global emissions of mercury (Hg) from coal-fired power plants are estimated to be over 600 tons annually, which accounts for about one third of the Hg total emissions (USEPA 2005). Mercury is a trace element in coal; nonetheless, its emission into environment can be substantial due to the increasing demand for energy (USEPA 2005). U.S. coal-fired power plants emit approximately 48 tons of mercury per year (USEPA 2005). On Mar. 18, 2005, the U.S. EPA issued the first Clean Air Mercury Rule (CAMR) for the control of mercury emissions from coal-fired power plants, which requires an overall average reduction in mercury emissions of about 69% by 2018 (USEPA 2005; Davidson and Clarke 1996).

Three types of mercury must be considered: elemental Hg(0); oxidized forms, Hg(I) or Hg(II); and particulate, Hg(p) [2-10] (Davidson and Clarke 1996; Sloss 1995; Tewalt et al. 2001; Western Research Institute 2006; Zeng et al. 2004; Sun et al. 2006; Apogee Scientific Inc. 2004; Hutson et al. 2007; O'Dowd et al. 2006). The total mercury concentrations of flue gas range from 1 to 35 μg/m³ (O'Dowd et al. 2006). Mercury from coal combustion is released mainly as Hg(0) since the thermodynamic equilibrium favors this state at coal combustion temperatures. Oxidized forms of mercury are easier to capture by conventional methods such as electrostatic precipitators, baghouses and sorbent injection.

People are increasingly interested in using solid sorbents for mercury removal, since their applications can be easily realized through injection at appropriate points upstream of an existing particulate device, and activated carbon has been considered to be the most promising sorbent due to its injection suitability, wide availability and acceptable prices. To further decrease the cost of mercury removal with carbon sorbents, the Department of Energy's National Energy Technology Laboratory (NETL) has developed Thief carbons. Thief carbon is obtained by inserting a lance in or near the flame, extracting a mixture of partially combusted coal and gas, and reinserting the mixture in the flue gas because its adsorptive properties are suited for mercury removal at cooler flue gas conditions. The tests conducted by NETL have demonstrated that the mercury sorption capacities of Thief carbons and commercial activated carbons are close, but Thief carbon based processes are less expensive because the production costs of Thief carbons are lower.

Sorbent surface modification has previously been used for enhancement of mercury sorption capacity of activated carbon (Zeng et al. 2004; Azhar Uddin et al. 2008; Schofield 2004; Bansal et al. 1988). For example, Zeng et al. (Zeng et al. 2004) demonstrated a fivefold increase of the original mercury sorption capacity by impregnating activated carbon with zinc chloride. Nitric and other acids can also enhance the mercury removal capacity of activated carbons (Western Research Institute 2006). The change of sorption mechanism resulting from surface modification is the driving force of sorption capacity of modified activated carbon (Zeng et al. 2004; Bansal et al. 1988). However, study of the surface modification of Thief carbon for mercury sorption improvement has not been reported, which is the purpose of this work. The main objectives of the current study are to demonstrate the mercury removal capacity of Thief carbon and modified Thief carbons, to explain the mechanism of mercury adsorption by ferric chloride modified TC and to propose a kinetic model for such adsorption.

### BRIEF DESCRIPTION OF THE FIGURES

FIG. 1 is a schematic diagram of a preferred apparatus for mercury sorption.

FIG. 2 is a chart of the effect of surface area on the different sorbents ([Hg]ᵢ=10.1 μg/m³; carrier gas: air; flow rate=17.06 L/min; T=100° C.; absolute pressure=77.5 kPa; mass of sorbent=25 mg).

FIG. 3 is a chart of the high resolution XPS characterization of chlorine components of fresh 1298-72-003 FeCl₃ modified Thief carbon (350 W; 45.0°; 58.70 eV).

FIG. 4 is a chart of the high resolution XPS characterization of iron components of fresh 1298-72-003 FeCl₃ modified Thief carbon (350 W; 45.0°; 23.50 eV).

FIG. 5 is a chart of the comparison of temperature dependence of sorption capacities in Thief and modified Thief carbon sorbents ([Hg]ᵢ=10.1 μg/m³; carrier gas: air; flow rate=17.06 L/min; absolute pressure=77.5 kPa. mass of sorbent=25 mg).

FIG. 6 is a chart of the effect of the flow rate on the sorption capacity (carrier gas: air; T=100° C.; mass of sorbent=25 mg).

FIG. 7 is a chart of the reaction order of Hg chemisorption on FeCl₃ impregnated thief carbon (ln rₐ vs ln p, carrier gas: air; T=100° C.; mass of sorbent=25 mg).

FIG. 8 is a chart of the Arrhenius plot for Hg chemisorption on FeCl₃ impregnated thief carbon (ln k vs −1/T, carrier gas: air; T=100° C.-200° C.; absolute pressure=77.5 kPa; mass of sorbent=25 mg.)

### DETAILED DESCRIPTION OF PREFERRED EMBODIMENTS OF THE INVENTION

A thermally activated sorbent can be obtained by retrieving partially combusted carbon, from the combustion zone of a furnace, for example the combustion chamber of a coal-fired power plant. To obtain the thermally activated sorbent, at least one lance, called a “thief”, is inserted into a location within the combustion zone of the combustion chamber and extracts a mixture of semi-combusted coal and gas. Thief carbons are produced when coal is withdrawn from a furnace after a brief residence time (approximately 0.1 to 2.5 seconds) near the burner flame. Suitable Thief carbons are those coal remnants containing carbon in concentrations between those found in raw coal and fly ash (completely combusted coal). Preferable ash composition of partially combusted coal (i.e. thief carbon substrate) is from of about 20 wt. percent ash to 80 wt. percent ash. The semi-combusted coal has adsorptive properties suitable for the removal of elemental and oxidized mercury.

Thief carbons are employed in a packed bed, monolith, or introduced via injection into the ductor upstream of a wet scrubber, ESP, or baghouse in order to facilitate the capture of Hg in coal burning power plants.

Thief carbons have BET surface areas of from about 30 m²/g to 250 m²/g. Typical particle sizes have diameters which range from of about 35 micrometers (μm) to 45 μm. The Thief carbon, or partially combusted coal, is withdrawn from the furnace, near the flame, after a brief residence time on the order of one second. Thief carbons are inexpensive, with an estimated cost of $90 to $250 per ton.

Preferred surface areas of treated Thief carbon catalysts range from of about 10 m²/g to 300 m²/g.

The Thief carbon catalyst can be used in the temperature range of from about 20° C. to 425° C., with the preferred temperature range being from about 38° C. to 300° C., and even more preferably from about 60° C. to 205° C.

Thief carbon sorbents (TCs) in this study were obtained from Western Research Institute (WRI). The sorbents were prepared from Powder River Basin sub-bituminous coal. Table 1 shows the temperature at which they were extracted from the furnace.

TABLE 1
BET surface areas of prepared Thief carbon sorbents

| | | | Surface area | Surface area |
|---|---|---|---|---|
| | Preparation | | (m²/g) after | (m²/g) after |
| | temperature | Surface area | modification | modification |
| Sample | (° C.) | (m²/g) | with FeCl₃ | with NaCl |
| 1298-67-002 | 932 | 143.5 | 107 | 123 |
| 1298-72-001 | 1,025 | 254 | 179 | 189 |
| 1298-73-002 | 1,039 | 326 | 188 | 217 |

Thief carbon sorbents were modified by impregnation with 4.85 wt % solutions of NaCl (Fisher Scientific, 99% purity) or FeCl₃ (J T Baker, 95% purity). The weight ratio of modifying agent (FeCl₃ or NaCl) to TCs was 1/40; it was determined that with this ratio, a complete or saturated impregnation could be achieved. The TCs were modified by mixing appropriate amounts of TCs with the solutions, subsequently they were washed, and finally they were then dried for 12 hours at 90° C. (Azhar Uddin et al. 2008). The surface areas of nine modified TC samples (3 raw TCs, 3 FeCl₃ modified TCs, and 3 NaCl modified TCs) were measured by nitrogen physisorption with a Micromeritics Tristar 3000 surface area and porosity analyzer.

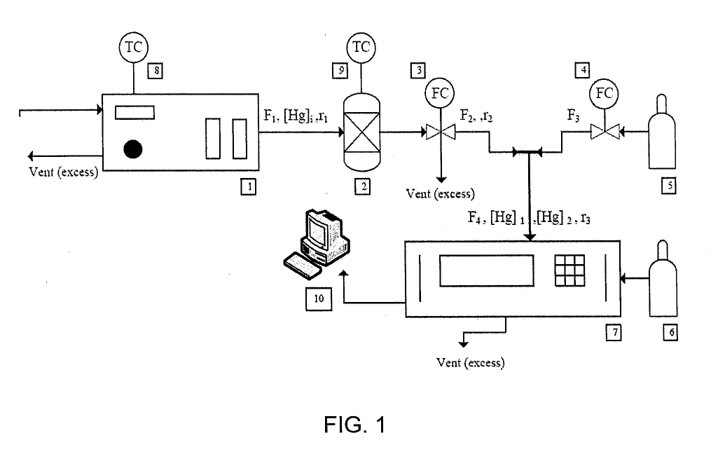

The mercury removal experimental setup consists of four parts (FIG. 1): a mercury generation unit, a dilution unit, a sorption system, and equipment for analyzing mercury vapor in the gas stream. Teflon (PTFE) lines (0.635 cm ID) and fittings were used to connect all streams. To perform the mercury sorption tests, an air stream flowing at 10.4, 17.06, or 22.6 L/min was introduced as a carrier gas into the chamber of the mercury generator, a VICI Metronics Dynacalibrator 450-548a (1), which generated 1,840 ng-Hg/min at 100° C. At these conditions, the total pressure was 77.5 kPa, which is the approximate atmospheric pressure at the ˜2,200 m elevation of the laboratory in which the research was done. Due to the small capacity (25 mg of sorbent) of the packed bed reactor used in this research, only a slip stream (0.05 L/min) of the Hg containing air was passed through the packed Hg sorption bed (2) held between quartz wool plugs. One of the plugs is located at a notch 0.2 m from one end of a 0.5 m×0.95 cm ID quartz tube. One part of the outlet (post-adsorption) gas stream was vented to a safe location, while the remaining part was metered by a flow controller (3) and diluted with another metered (4) air stream provided by air cylinder (5) to reduce the Hg concentration to measurable levels using a TEKRAN 2537-S mercury analyzer (7). The Hg sorption profiles were collected and recorded using a data acquisition system (10). Blank sorption tests were performed to determine the Hg sorption capacity of the tested sorbents.

Three factors, the surface areas of sorbents, the Hg concentrations in the gas stream, and sorption temperature, were studied for their effects on Hg sorption. Raw TCs and FeCl₃ modified TCs were tested over sorption temperature ranges of 25-200° C. and 25-300° C., respectively. The flow rates varied from 10.4 to 22.6 L/min. The same tests were conducted for NaCl modified TCs. In addition, the kinetics of FeCl₃ modified TCs based Hg adsorption was investigated over temperature and gas flow rate ranges of 100-200° C. and 10.4-22.6 L/min, respectively.

X-ray photoelectron spectroscopy (XPS) and X-ray fluorescence (XRF) tests were performed on some FeCl₃ modified TCs to study their Hg sorption mechanism. The XPS tests were performed using a Phi-5800 spectrometer with a monochromatic Al Kα X-ray source, a hemispherical analyzer, and a multichannel detector. The C 1s and Hg peaks should be at 284.8 eV and 99-101 eV, respectively (Yang et al. 2007; Hutson et al. 2007; Moulder et al. 1992; Brunauer et al. 1938; Suzuki 2002; Beckhoff et al. 2006; McCurdy et al. 2004). The XRF characterization tests were performed with a SPECTRO MIDEX XRF spectrometer to test if Hg⁰ is oxidized to Hg²⁺. Table 2 shows the results of the amount of mercury adsorbed to the surface of a sample of FeCl₃.

TABLE 2
Amount of Mercury Adsorbed

| | Concentration in | |
|---|---|---|
| | wt % of sample | Concentration in wt % |
| | 1298-73-002 | of sample 1298-73-002 |
| | modified with | modified with FeCl₃, |
| Element | FeCl₃, fresh | spent |
| Hg | 0 | 0.171 ± 0.005 |
| Fe | 9.72 ± 0.09 | 3.32 ± 0.02 |
| Cl | 6.31 ± 0.04 | 5.29 ± 0.04 |

It can be seen in this case, that mercury was oxidized to Hg²⁺, since the compound found was HgO. The instrument was operated at 55 kV and 1 mA with an energy resolution of 155 eV.

Mercury adsorption kinetics of the FeCl₃ modified TC 1298-73-002 sample was studied over a temperature range of 100-200° C. The flow rate of air was regulated to vary the concentration of mercury in the gas stream to obtain the sorption kinetics. The Hg removal efficiencies of all the tests run for kinetic study were kept below 10% to obtain initial rate results. The reaction order was evaluated by calculating the chemisorption based on the sorption rate of Hg⁰ at different concentrations and then plotting the logarithm of those rates against the logarithm of the Hg partial pressures. Finally, the activation energy was obtained from an Arrhenius plot of the logarithm of k versus −1/T.

### Results and Discussion

Effects of Different Factors on Adsorption

Surface Area and Modification

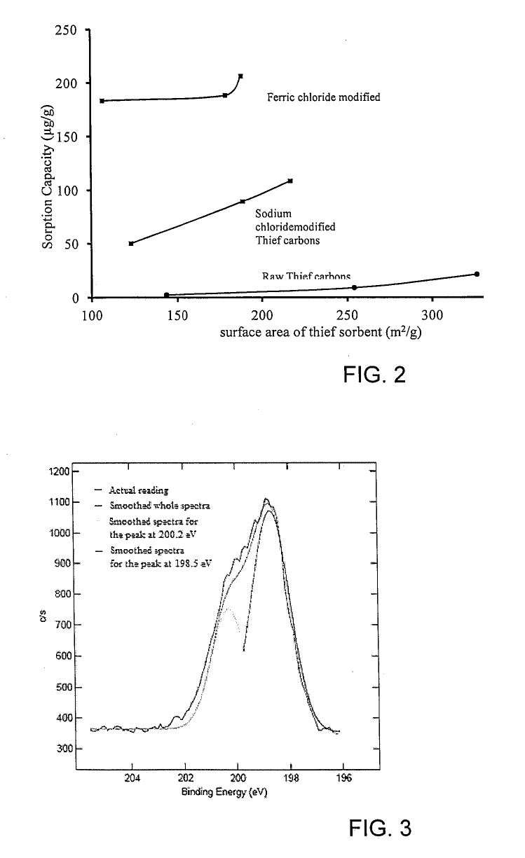

The measured surface areas of the nine TC samples (3 raw TCs, 3 FeCl₃ modified TCs, and 3 NaCl modified TCs) range from 107 to 346 m² g⁻¹ (Table 1). The temperature of the combustor at which the three unmodified samples were withdrawn from the combustor is also shown. The surface areas of the three untreated samples increased with the temperature at which they were withdrawn from the combustor increased. The surface areas of the treated samples decrease by about 20 to 40% of the untreated samples, presumably due to pore plugging by the added FeCl₃ or NaCl. The sorption capacities of all the sorbents increased with the increase of their surface areas, while those of raw TCs are very low as expected for activated carbon, since they are physical sorbents (FIG. 2). The breakthrough capacity in FIG. 2 was calculated as follows: firstly, the breakthrough is defined as 90% of the initial mercury concentration in the inlet continuous stream, secondly, by obtaining the total amount of mercury adsorbed until the breakthrough concentration was reached and dividing this amount by the weight of the sorbent used. It must be noticed that the breakthrough was calculated using FIG. 2. For this system, no full isotherm or adsorption energy has been measured before.

The Hg sorption breakthrough capacities of the different sorbents are calculated based on FIG. 2 and listed in Table 3.

TABLE 3
Sorption capacities* of raw and modified Thief carbon

| | | | | FeCl₃ impregnated | | | NaCl impregnated | | |
|---|---|---|---|---|---|---|---|---|---|
| | Raw Thief carbon | | | Thief carbon | | | Thief carbon | | |
| | Surface | Capacity | Removal | Surface | Capacity | Removal | Surface | Capacity | Removal |
| | area | (μg | efficiency | area | (μg | efficiency | area | (μg | efficiency |
| Sample | (m²/g) | Hg/g) | (%) | (m²/g) | Hg/g) | (%) | (m²/g) | Hg/g) | (%) |
| Sample | 143.5 | 21.27 | 83 | 107 | 188.5 | 97.2 | 123 | 70.19 | 97 |
| 1298-67- | | | | | | | | | |
| 002 | | | | | | | | | |
| Sample | 254 | 8.96 | 97 | 179 | 195.0 | 97.7 | 189 | 89.19 | 99 |
| 1298-72- | | | | | | | | | |
| 001 | | | | | | | | | |
| Sample | 326 | 2.49 | 98.6 | 188 | 206.2 | 99.0 | 217 | 108.5 | 98 |
| 1298-73- | | | | | | | | | |
| 002 | | | | | | | | | |

*[Hg]ᵢ = 10.1 μg/m³; carrier gas: air; flow rate = 17.06 L/min; T = 100° C.; absolute pressure = 77.5 kPa; weight of sorbent = 25 mg

In Table 2, the removal efficiencies refer to the maximum amount of mercury that can be removed during a continuous process and before the sorbent is spent, it is generally expressed as a percentage of the inlet stream. Modified TCs have higher Hg adsorption capacities than corresponding raw TCs (Table 3). Furthermore the FeCl₃ modified TCs possess significantly higher Hg sorption capacities than the NaCl impregnated samples (FIG. 2 and Table 3). Nevertheless, both have sorption capacities on order of 10 to 100 times higher than the unmodified TCs, explained as follows. It can be remarked that although the sorption capacities seem to be correlated to the sorption efficiency in the case of Raw TCs, this fact cannot be concluded, and it is not the case for surface modified TCs. The sorption efficiency can be more related to the interaction between mercury molecules and the structure of the TC, while the capacity is more likely related to the nature of the adsorption in terms of total amount of available sites and reactants in the case of the chmisorption.

Surface area plays an important role in determining the Hg sorption capacity of a physisorbent because it is directly related to the total number of sorption sites where Hg can be adsorbed (Zeng et al. 2004). Physical adsorption apparently dominates the Hg adsorption with raw TCs, while the NaCl and the FeCl₃ impregnated TCs depend on both physisorption and chemisorption for the removal of adsorbed mercury, due to the introduction of Cl⁻ and formation of CF surface complexes, Cl₂—CₙHₓO_{y} (Tewalt et al. 2001; Bansal et al. 1988). The major interactions between Hg⁰ and CF (Zeng et al. 2004; Bansal et al. 1988) are

Hg⁰+[Cl⁻] [symbol] HgCl⁺+2e Eq. (1)

3Hg⁰+6[Cl] [symbol] 3[HgCl₂]+6e Eq. (2)

These reactions may be preceded by the formation of the reduced chlorine complex on the carbon surface as proposed by Zeng et al. and Bansal (Zeng et al. 2004; Bansal et al. 1988) by the following reaction

FeCl₃+CₙHₓO_{y} [symbol] Fe³⁺+[Cl₃—CₙHₓO_{y}]³⁻ (E3)

The samples were characterized with XPS measurements due to the capability of such characterization of distinguishing different species in the spent sample, specifically, the organic halide, which confirms that the proposed mechanism is possible. The organic halide is a relevant species because it is the precursor of the formation of mercuric chloride. This is confirmed with our XPS characterization results of the spent FeCl₃ modified Thief carbon (FIG. 3) which show the organic chloride species on the right side of E3 are present in the region of 198-200 eV. The double peak is a result of the Cl 2p^{3/2} and 2p^{1/2} excitations (FIG. 3). FeCl₃ modified TCs are less dependent on the surface area than NaCl modified ones, as (FIG. 2 and Table 3), which can be explained by Fe³⁺ in FeCl₃ being a much stronger oxidant than Na⁺ in NaCl. That is, the oxidant effect is much more relevant in the case of FeCl₃ modified TCs than the surface area effect. It can oxidize Hg⁰ according to the following reactions:

2Fe³⁺+Hg⁰ [symbol] 2Fe²⁺+Hg²⁺ (E4)

Fe³⁺+Hg⁰ [symbol] Fe²⁺+Hg⁺ (E5)

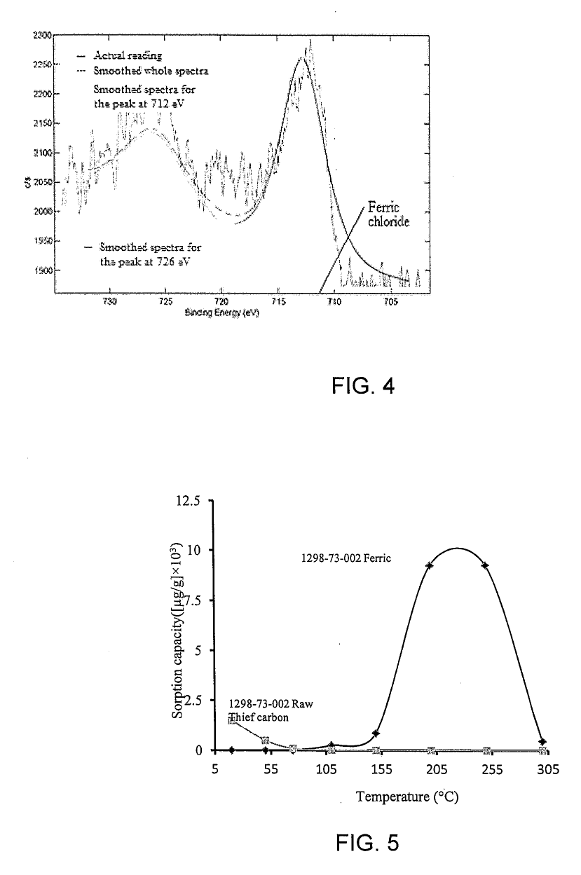

The XRF characterization shown in Table 2 and the XPS characterization in FIG. 4 demonstrate that Fe³⁺ is the predominant iron species. The resulting Hg⁺ and Hg²⁺ can form oxides or combine with Cl⁻ to form stable salts, while Na⁺ cannot oxidize Hg⁰ at all, which is only physisorbed on TCs, as observed by Huston et al. (Hutson et al. 2007) when they studied the behavior of Hg on sorbents impregnated with halide salts.

High resolution XPS characterization fresh 1298-72-003 FeCl₃ modified TC prior to sorption found that FeCl₃ exists in the modified TC, since its peak appears at 714 eV, very close to 711 eV found by Moulder (Moulder et al. 1992) (FIG. 4). In FIG. 4, the label ferric chloride refers to the position of ferric chloride in the spectra, that is, at 708 eV. This finding supports the postulated E4 and E5 due to the participation of Fe³⁺ in oxidizing Hg⁰.

To further support this proposed mechanism, the existence of an oxidized form of mercury (Hg²⁺) on the spent modified TCs needs to be demonstrated. XPS can potentially be used to determine the presence of oxidized Hg species on the surface of the spent TCs. However, the peaks of silicon and Hg²⁺ in the spent TCs are present at the same binding energy location of XPS (Moulder et al. 1992) and the concentrations of silicon are much higher than those of Hg²⁺; thus, XPS cannot be used a tool to identify Hg²⁺ in spent TCs. The source of silicon in the samples is the TC itself, since coal contains silicon. XRF was used in this research to identify and estimate the quantity of Hg²⁺ in the spent FeCl₃ modified TC 1298-73-002. The XRF analyses show that no mercury was found in raw TC 1298-73-002, but its Hg concentration after sorption was 0.0171 wt % in terms of HgO, which is consistent with the calculated Hg sorption capacity listed in Table 2. XRF analyses can distinguish the species of mercury since the test shows which compounds are present in the sample and not only which elements (Janssens et al. 2000)

Temperature Effect

Unlike physical elemental mercury sorption, in which the Hg surface binding rate is inversely related to temperature but proportional to surface area, the subsequent chemisorption (via oxidation) of Hg by FeCl₃ modified TC has a significant temperature dependence according to the Arrhenius equation. This is particularly true in the case of endothermic or entropy driven reactions. FIG. 5 shows the dependence on temperature of raw and FeCl₃ modified TC 1298-73-002, with respect to its Hg sorption capacity, in terms of the mass of mercury adsorbed on per unit mass of sorbent. These results show that the Hg adsorption capacities of raw TC 1298-73-002 are not only low at all the tested temperatures, but also decrease with increasing temperature, which is the consistent with the statement that the adsorption mechanism is in this case is physical. Physisorption shows this behavior because the Van der Waal interactions are more weakly bonded at higher temperatures, therefore desorption is more likely to occur. However, the modified TC 1298-73-002 shows a different temperature dependence trend. Its Hg sorption capacity is very low in the temperature range of 20-150° C. where physical sorption dominates, increases with increasing isothermal sorption temperature from 150-225° C., and then decreases with further increases of sorption temperature. This complex behavior can be explained as follows. Chemisorption via oxidation controls the Hg sorption of the modified TC 1298-73-002 when sorption tests were conducted above 150° C. Higher temperatures favor the oxidation, and thus the chemisorption, of Hg as found in the temperature range of 150° C.-225° C. (FIG. 5). However, further increases of sorption temperature are not beneficial to the overall sorption of mercury because some of mercury compounds formed through oxidation and chemisorption, such as Hg₂O and HgCl₂, start to decompose. These observations strongly support the chemisorption mechanism induced by the introduction of FeCl₃ to the surface of raw TC.

Initial Hg Concentration

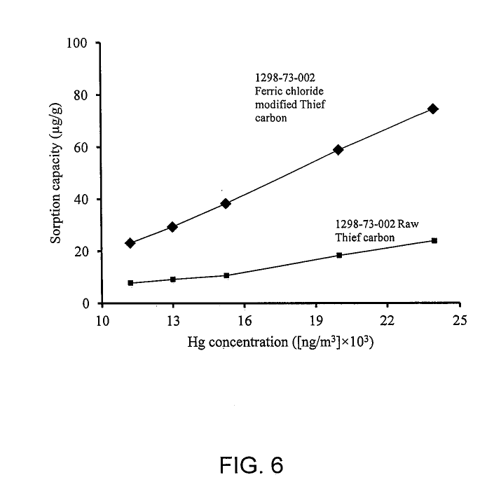

The effect of initial gas phase Hg breakthrough concentration was studied in the range of 10 to 25 μg/m³. The data collected for both raw and FeCl₃ modified TCs 1298-73-002 are presented in FIG. 6. Higher initial Hg concentrations lead to increased Hg breakthrough sorption capacity, as expected from Langmurian theory of adsorption isotherms. FIG. 6 shows this tendency, although it cannot be proven with the data obtained that this behavior will persist. Higher concentrations correspond to lower flow rates. The increase in the sorption capacity at higher concentrations is larger for ferric chloride modified Thief carbon than for raw Thief carbon. The sorption capacities between FIG. 6 and FIG. 5 appear different because the vertical axis in FIG. 5 is multiplied by a factor of 10³.

Reaction Kinetics

Under the given chemisorption conditions (relatively low sorption temperatures and Hg sorption efficiencies), the desorption of Hg can be neglected. As such, the chemisorption rates, rₐ, can be calculated based on the conversion of Hg⁰ using the following equation:

$${r}_{a} = X \times \frac{{[ Hg ]}_{i}}{Δ t} \qquad ( E6 )$$

where X is the Hg⁰ conversion (%), [Hg]ᵢ is the initial concentration of Hg⁰ in the stream (mol/min), and Δt is the time interval of two consecutive sampling points. rₐ can also be expressed as:

rₐ=kp_{Hg}_{⁰}ⁿ (E7)

where k is the rate constant of the chemisorption in mol/m³·s, n is the sorption order with respect to Hg⁰, and p_{Hg}_{⁰} is the partial pressure of elemental mercury, so:

ln rₐ=ln k+n ln p_{Hg}_{⁰} (E8)

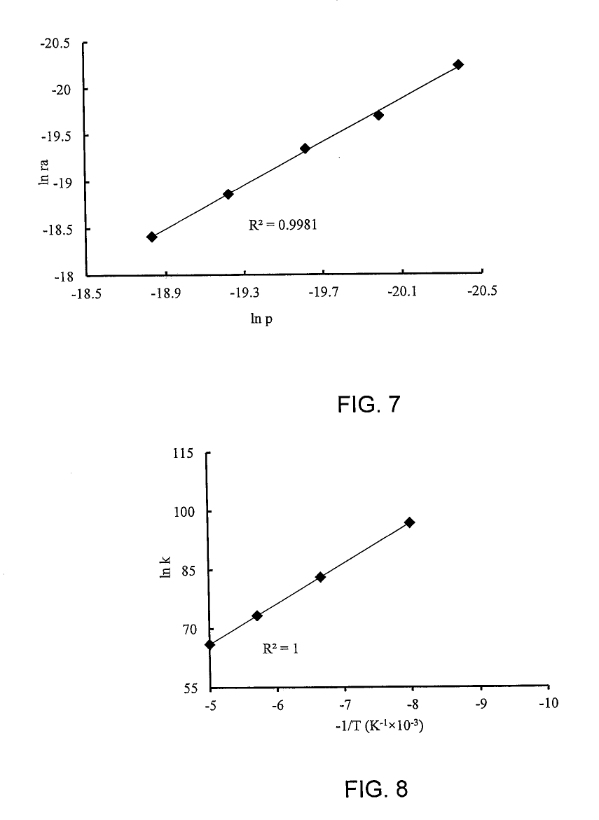

The values of k and n can be obtained using E8 since n and in k are the slope and intercept of a plot of ln rₐ versus ln p_{Hg}_{⁰} (e.g., FIG. 7 for 100° C.), which suggests the sorption order with respect to Hg⁰ is 1. The k values obtained at different temperatures were plotted in an Arrhenius form of ln k˜(−1/T) to obtain the activation energy of the FeCl₃ modified TC 1298-73-002 based Hg⁰ sorption from the slope of the plotted line (e.g., FIG. 8). Based on the slope and intercept of the plot, the activation energy, Eₐ, and pre-exponential factor, A, for Hg⁰ chemisorption are 85.6 kJ/mol·K and 2.03×10⁶, respectively. The activation energy could be the indicator that the reaction E3 is the rate limiting step with the formation of the chlorine halide which is the precursor of the oxidized mercury. The corresponding Arrhenius form of the rate constant is

$$k = A {e}^{- \frac{85 , 578}{RT}} \qquad ( E9 )$$

where R is the ideal gas constant with units of mol/J·K and T has units of K.

### CONCLUSIONS

The mercury sorption capacities of Thief carbons modified with FeCl₃ and NaCl are considerably enhanced relative to unmodified Thief carbon. For example, modification of a Thief carbon with ferric chloride can increase its mercury sorption capacity from 21 μg/g to 206 μg/g, despite a decrease in surface area from 326 m²/g to 217 m²/g. This increase in sorption capacity appears to be due to a change in their mercury sorption mechanism. Whereas unmodified Thief carbon displays a decreasing sorption capacity with increasing isothermal sorption temperatures, which is a hallmark of physisorption processes, the Cl-modified forms display more complicated temperature dependences that are consistent with chemisorption. FeCl₃ is a better modification agent than NaCl, with about 4-times higher Hg capacity, because Fe³⁺ can oxidize the Hg to more active forms that form chlorine compounds, while Na⁺ cannot. XPS and XRF characterizations show the presence of surface organic chloride species, FeCl₃, and HgO, which support the proposed chemisorption mechanism in modified Thief carbons. Based on kinetic studies, the observed reaction order is 1, while the activation energy is 85.6 kJ/mol·K for Hg chemisorption on FeCl₃ modified Thief carbon.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

### REFERENCES

Apogee Scientific Inc. (2004). “Assessment of Low Cost Novel Sorbents for Coal-Fired Power Plant Mercury Control, Final Report.” http://www.osti.gov/bridge/servlets/purl/835235-AL9b5h/native/835235.pdf, accessed October 2006.
Azhar Uddin, M. D.; Yamada, T.; Ryota O.; Sasaoka, E. (2008). “Role of SO2 for Elemental Mercury Removal from Coal Combustion flue Gas by Activated Carbon.” Energy & Fuels., 22, 2284-2289.
Bansal, R. C.; Donnet, J. B.; Stoeckli, F. (1988). “Active carbon.” Marcel Dekker, New York.
Beckhoff, B.; Kanngieβer, B. Langhoff, N.; Wedell, N. R.; Wolff, H. (2006). “Handbook of Practical X-Ray Fluorescence Analysis.” Springer.
Brunauer, P.; Emmett, H.; Teller, E. (1938). “Adsorption of Gases in Multimolecular Layers.” J. Am. Chem. Soc., 60, 309-319.
Davidson, M.; Clarke, L. B. (1996). “Trace elements in coal.” IEA Perspective Report IEAPR/21.
Hutson, N.; Atwood, B.; Scheckel, K. (2007). “XAS and XPS Characterization of Mercury Binding on Brominated Activated Carbon.” Environ. Sci. Technol., 41, 1747-1752.
Janssens K.; Vittiglio G.; Deraedt I.; Aerts A.; Vekemans B.; Vincze L.; Wei F.; Deryck I.; Schalm O.; Adams F.; Rindby A.; Knochel A.; Simionovici A.; Snigirev A. (2000). “Use of Microscopic XRF for Non-destructive Analysis in Art and Archaeometry.” X-Ray Spectrom., 29, 73-91.
McCurdy, P. R.; Sturgess, L. J.; Kohli, S.; Fisher, E. R. (2004). “Investigation of the PECVD TiO2—Si(1 0 0) interface.” Appl. Surf Sci., 233, 69-79.
Moulder, J. F.; Stickle, W. F.; Sobol, P. E.; Bomben, K. D. (1992). “Handbook of X-ray Photoelectron Spectroscopy.” Perkin-Elmer Corporation (Physical Electronics Division).
O'Dowd, W. J.; Pennline, H. W.; Freeman, M. C.; Granite, E. J.; Hargis, R. A.; Lacher, C. J.; Karash, A. (2006). “A technique to control mercury from flue gas: The Thief Process.” Fuel Process. Technol., 87, 1071-1084.
Schofield, K. (2004). “Let them eat fish: Hold the mercury.” Chem. Phys. Lett., 65,386.
Sloss, L. L. (1995). “Mercury emissions and effects: the role of coal.” IEAPER/19, IEA Coal Research, London, UK.
Sun, W.; Yan, N.; Jia, J. (2006). “Removal of elemental mercury in flue gas by brominated activated carbon.” China Environ. Sci., 26, 257-261.
Suzuki, E. (2002). “High-resolution scanning electron microscopy of immunogold-labelled cells by the use of thin plasma coating of osmium.” Journal of Microscopy, 208, 153-157.
Tewalt, S. J.; Bragg, L. J.; Finkelman, R. (2001). “Mercury in U.S. Coal—Abundance, Distribution, and Modes of Occurrence.” http://pubs.usgs.gov/fs/fs095-01/fs095-01.pdf USGS Fact Sheet FS-095-01.
US EPA. (2005). “Clean Air Mercury Rule.” www.epa.gov/mercury.
Western Research Institute. (2006). “Removal of Mercury From Coal Derived Synthesis; Final Report for Base Task 1.i Under DE-FC26-98FT40322.” http://www.osti.gov/bridge/purl.cover.jsp;jsessionid=F76765B74E22C9EFB9255 E5F5DEAB43 1?purl=/882283-IrdtNX/, accessed September 2008.
Yang, H.; Xua, Z.; Fan, M.; Bland A.; Judkins R. (2007). “Adsorbents for capturing mercury in coal-fired boiler flue gas.” J. Hazard. Mater., 146, 1-11.
Zeng, H.; Feng, J.; Guo, J. (2004). “Removal of elemental mercury from coal combustion flue gas by chloride-impregnated activated carbon.” Fuel, 83, 143-146

We claim:

1. Sorbents for mercury, comprising carbon sorbents impregnated with a metal salt.

2. Sorbents as defined in claim 1, wherein the metal salts are selected from the group consisting of ferric chloride and sodium chloride.

3. A process for a sorbent for mercury, comprising the steps of:
(a) preparing a solution of a metal salt;
(b) adding the solution to a carbon sorbent; and
(c) drying the modified carbon sorbent.

4. A process for absorbing mercury from flue gases, comprising the step of passing the flue gas over a sorbent of claim 1.

5. A process for absorbing mercury from flue gases, comprising the step of passing the flue gas over a modified carbon sorbent of claim 3.
